(19) United States
(12) Patent Application Publication
(10) Pub. No.: US 2025/0076183 A1
(43) Pub. Date: Mar. 6, 2025

(54) SYSTEM AND METHOD FOR ENHANCED INSPECTION OF SURFACES WITH SPECULAR REFLECTION

(71) Applicant: Orbotech Ltd., Yavne (IL)

(72) Inventors: Haim Chayet, Nes Ziona (IL); Manuela Hod, Moshav Nir Banim (IL)

(21) Appl. No.: 18/239,005

(22) Filed: Aug. 28, 2023

(51) Int. Cl. G01N 21/01; G01N 21/47; G01N 21/95

(52) U.S. Cl. CPC G01N 21/01; G01N 21/4738; G01N 21/9501

(57) ABSTRACT

An inspection system for enhancing diffuse scattering from a sample during inspection of includes a stage and an optical sub-system, wherein the optical sub-system includes an illumination source, one or more optical elements, and a camera. The inspection system also includes one or more fluid delivery nozzles positioned proximate to the stage. The one or more fluid delivery nozzles are configured to deliver a fluid to the one or more reflective components of the sample via a fluid stream to temporarily cause adsorption of a material on a surface of the one or more reflective components of the sample to cause temporary enhancement of diffuse scattering from the one or more reflective components of the sample. The camera is configured to image the one or more reflective components of the sample during the temporary enhancement of diffuse scattering from the one or more reflective components of the sample.

### TECHNICAL FIELD

The present application relates to inspection of sample surfaces, and, in particular, to inspection of silicon wafer and PCB surfaces containing specular reflective components.

### BACKGROUND

The inspection of optically highly reflective structures such as metals is physically challenging. Due to the dominance of specular reflection from these surfaces, the illumination of highly reflective structures typically leads to surface glare, often to saturation, and distortion of collected image brightness. The imaging of surfaces with high curvature (e.g., spherical surfaces of ball grid arrays (BGA)), introduces further complications. When light is reflected from a flat mirror, it reflects off the mirror surface at the same angle it impinged the mirror but in the opposite direction. This type of reflection, often referred to as “specular reflection,” is the dominant reflection mode for mirror-like surfaces. Unlike mirror-like surfaces, in surfaces that exhibit diffuse reflection, the reflection of light is scattered at many angles rather than at just one angle as in the case of specular reflection. The origin of the different properties of reflection lies in microscopic structure of the surface, such as roughness, and scattering centers that lie beneath the surface. In highly polished metal surfaces, the reflection is essentially specular; light is reflected at the angle cone subtended by the light source and only a small fraction of reflection is diffuse, that is, is scattered uniformly in other directions. For example, as shown in FIG. 1, consider the optical inspection of a curved surface illuminated with a light source incident at a given angle. Light incident from different locations on the surface is reflected in different directions according the orientation of the surface. A camera placed at any given angle to the surface will collect the light coming from only a small area of the surface, while light reflected from other portions of the surface will not reach the camera. The small fraction of diffuse light that does reach the camera is easily drowned out by the strong specular reflections coming from different portions of the curved surface. Therefore, inspection and the extraction of structural data (e.g., height and shape factors of an object) requires illumination and camera arrangements to cover a very broad angular spectrum. This leads to complex imaging and illumination modalities.

Current techniques implemented to overcome the physical challenges of imaging curved highly-reflective surfaces include i) white light interferometry; ii) general interferometry; iii) structured light; iv) time-of-flight measurements; and v) depth from focus. These techniques are complex and expensive, and are limited to sample size and geometry and are often poor quality and low resolution. Therefore, there is a need to provide a system and method of inspection that overcomes the limitations of previous approaches as described above.

### SUMMARY

An inspection system is disclosed, in accordance with one or more embodiments of the disclosure. In embodiments, the inspection system comprises a stage, wherein the stage is configured to secure a sample including one or more reflective components. In embodiments, the inspection system comprises an optical sub-system, wherein the optical sub-system includes an illumination source, one or more optical elements, and a camera. In embodiments, the inspection system comprises one or more fluid delivery nozzles positioned proximate to the stage. In embodiments, the one or more fluid delivery nozzles are configured to deliver a fluid (e.g., gas and/or liquid) to the one or more reflective components of the sample via a fluid stream to temporarily cause adsorption of a material on a surface of the one or more reflective components of the sample to cause temporary enhancement of diffuse scattering from the one or more reflective components of the sample. In embodiments, the camera is configured to image the one or more reflective components of the sample during the temporary enhancement of diffuse scattering from the one or more reflective components of the sample.

A method for inspecting a sample is disclosed, in accordance with one or more embodiments of the present disclosure. In embodiments, the method includes positioning a sample including one or more reflective components for inspection with an inspection tool. In embodiments, the method includes treating the one or more reflective components of the sample with a fluid stream to temporarily adsorb a material on a surface of the one or more reflective components of the sample to cause temporary enhancement of diffuse scattering from the one or more reflective components of the sample. In embodiments, the method includes imaging the one or more reflective components of the sample during the temporary enhancement of diffuse scattering from the one or more reflective components of the sample.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure

### BRIEF DESCRIPTION OF DRAWINGS

The numerous advantages of the disclosure may be better understood by those skilled in the art by reference to the accompanying figures.

FIG. 1 illustrates a conceptual view of the light reflecting from a curved reflective surface, in accordance with one or more embodiments of the present disclosure.

FIG. 2A illustrates a simplified schematic view of an inspection system configured to provide enhanced diffuse scattering from reflective surfaces, in accordance with one or more embodiments of the present disclosure.

FIGS. 2B and 2C illustrate a conceptual view of the enhancement of diffuse scattering from the surface of a reflective component of a sample, in accordance with one or more embodiments of the present disclosure.

FIG. 2D illustrates a simplified schematic view of an inspection system configured to provide enhanced diffuse scattering from reflective surfaces with multiple fluid delivery nozzles for providing multiple fluid streams, in accordance with one or more embodiments of the present disclosure.

FIG. 3 illustrates a process flow diagram depicting a method of inspecting a sample with enhanced diffuse scattering from reflective surfaces, in accordance with one or more embodiments of the present disclosure.

FIGS. 4A-4C illustrates a series of images depicting the temporary enhancement of diffuse scattering from the surface of a reflective component of a sample, in accordance with one or more embodiments of the present disclosure.

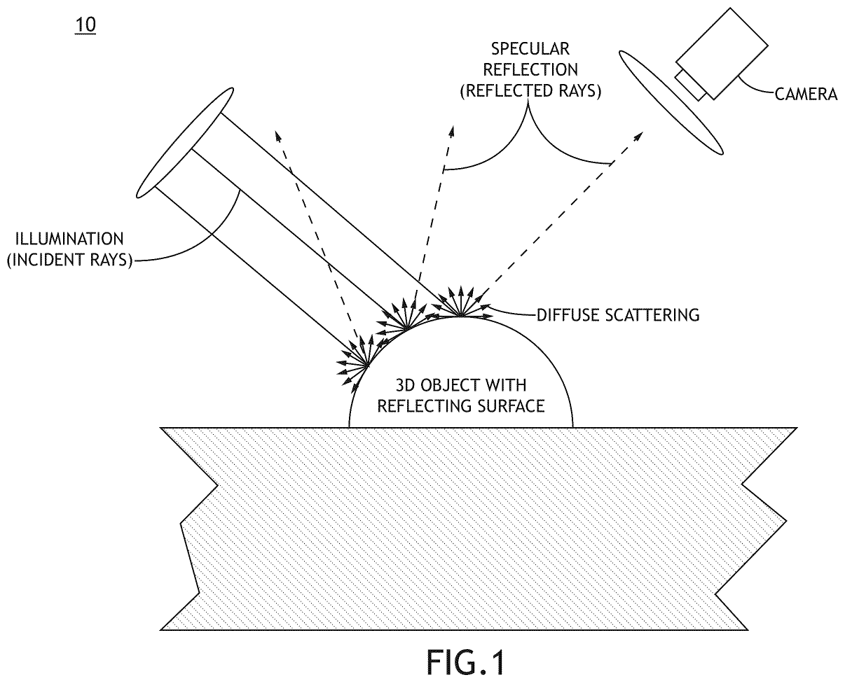

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to a method and system that reduce the physical complexity associated with imaging highly-reflective surfaces by altering, temporarily and reversibly, the reflecting properties of the surfaces from specular towards more diffuse reflection. Diffuse scattering/reflection from a given surface may be achieved by creating a film on the surface of the object via material (e.g., gas) adsorption. It is noted that adsorption is the adhesion of molecules, atoms, or ions from a gas, liquid or dissolved solid to a surface. This process creates a film of the adsorbate on the surface of the adsorbent. In embodiments of the present disclosure, the adsorbate is from a fluid phase (e.g., gas phase, liquid phase, or a mixture of gas and liquid). It is noted that adsorption is a surface phenomenon and differs from absorption, in which a fluid is dissolved by or permeates the solid. In one embodiment of the present disclosure, the reflective properties are temporarily and reversibly altered by stimulating water condensation on top of the reflective surface by rapid cooling of the surface. In an additional and/or alternative embodiment of the present disclosure, reflective properties of the reflective surfaces of a sample are altered by adsorption of a material from a fluid stream supplied to the surfaces from a fluid delivery nozzle.

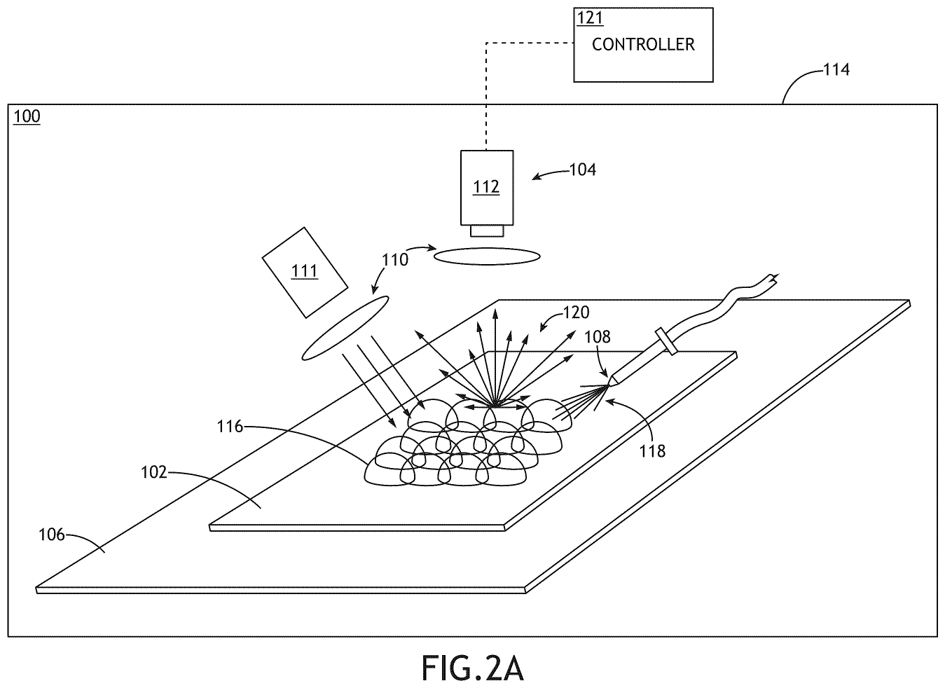

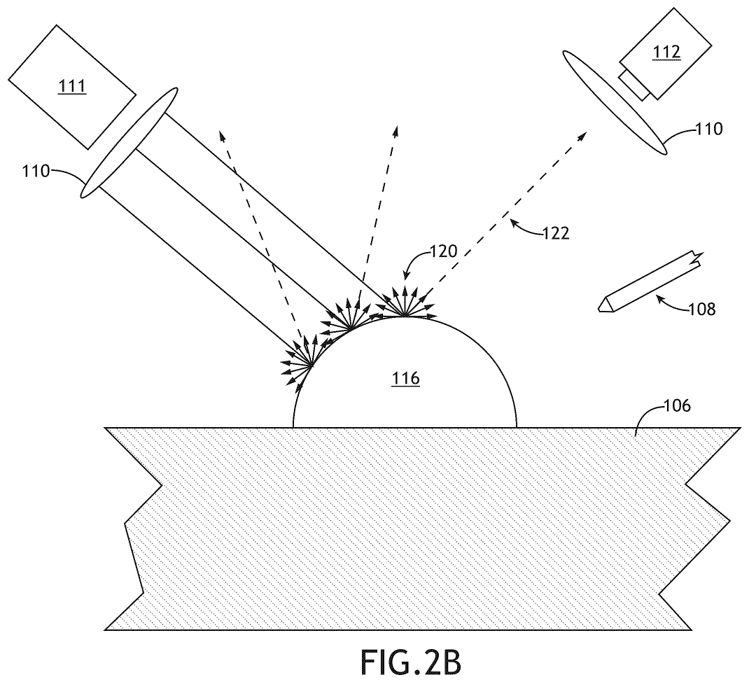

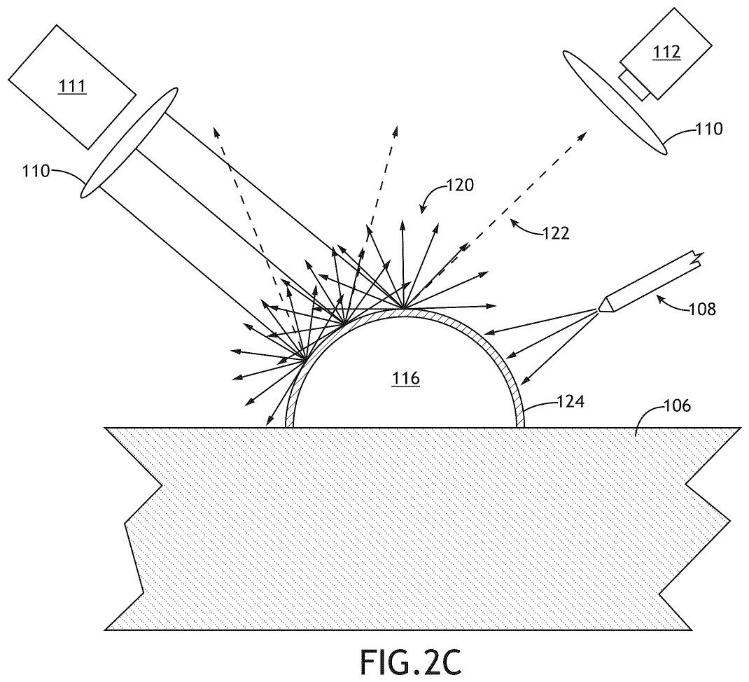

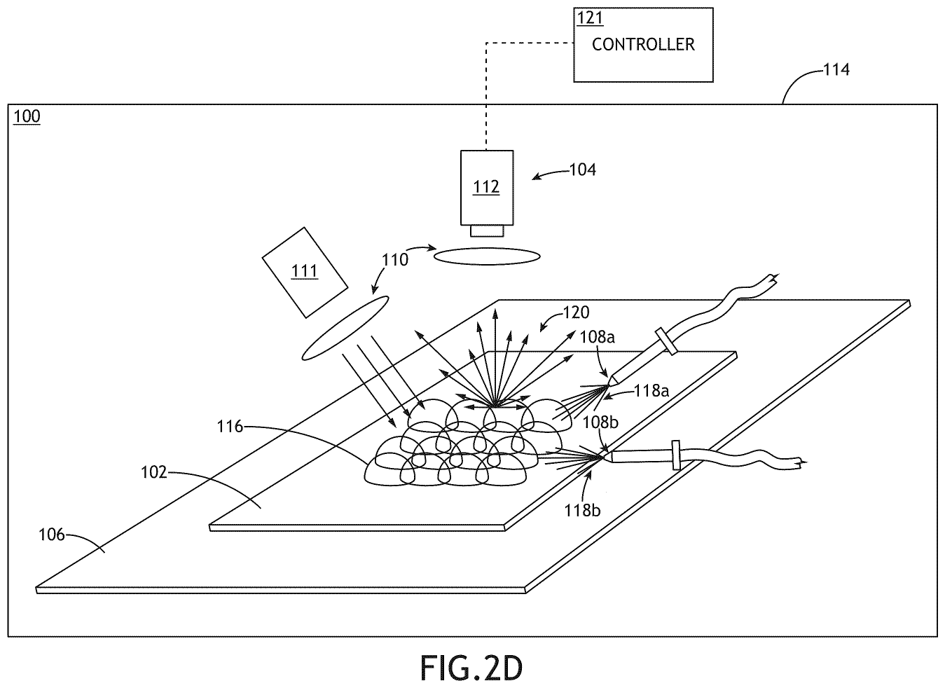

FIG. 2A illustrates an inspection system 100, in accordance with one or more embodiments of the present disclosure. The inspection system 100 may be configured to inspect or measure a sample 102. In embodiments, the inspection system 100 includes an optical sub-system 104, a stage 106, and one or more fluid delivery nozzles 108. In embodiments, the optical sub-system 104 includes one or more optical components 110 (e.g., illumination optics and/or collection optics), an illumination source 111, and a camera 112. In embodiments, the inspection system 100 is housed within a chamber 114. In embodiments, the stage 106 is configured to secure a sample including one or more reflective components 116. In embodiments, the one or more fluid delivery nozzles 108 are positioned proximate to the stage 106. The one or more fluid delivery nozzles 108 are configured to deliver a fluid to the one or more reflective components 116 of the sample 102 via a fluid stream 118 to temporarily cause adsorption of a material on a surface of the one or more reflective components 116 of the sample 102 to cause temporary enhancement of diffuse scattering 120 from the one or more reflective components 116 of the sample 102. In embodiments, the camera 112 is configured to image the one or more reflective components 116 of the sample 102 during the temporary enhancement of diffuse scattering 120 from the one or more reflective components 116 of the sample 102.

FIGS. 2B and 2C illustrate the enhancement of diffuse scattering 120 from the reflective components 116. For example, FIG. 2B depicts the original state of the sample 102 with reflective components 116 whereby specular reflection 122 dominates the diffuse scattering 120. In contrast, as shown in FIG. 2C, following treatment of the sample 102 to create an adsorption layer 124 on the surface of the reflective components 116, the diffuse scattering 120 intensity is enhanced relative to the specular reflection intensity. In embodiments, the sample 102 is placed under the inspection head and fluid stream is applied during a pre-set determined time during which adsorption occurs and the adsorption layer 124 is formed on a surface of the one or more reflective components 116. Once the surface transforms to diffuse reflection an image or a sequence of images are acquired by the camera 112 and controller 121. The procedure can be repeated several times with different gasses before moving to the new site of inspection.

In embodiments, the fluid stream 118 delivered by the one or more fluid nozzles 108 may contain a gas, a liquid, or a gas-liquid mixture. In embodiments, the fluid stream 118 is ambient fluid stream. For example, the ambient fluid stream may include an ambient gas stream formed from the same gas contained within the chamber 114. In embodiments, the fluid stream 118 cools the one or more reflective components 116 to cause water adsorption on a surface of the one or more reflective components 116. For example, the ambient gas stream may cool the one or more reflective components 116 via adiabatic expansion of the ambient gas (e.g., air) surrounding the reflective components 116, thereby causing water adsorption on the surface of the one or more reflective components. In this embodiment, the reflection properties are temporarily and reversibly altered by stimulating water condensation on top of the reflective surface by rapid cooling the surface. When the surface undergoes fast cooling beyond the dew point, a thin water condensate film is formed on the surface in presence of humidity in the ambient atmosphere. Water droplets in the condensate act as the light scattering centers that increase the diffuse fraction of reflection. When the surface temperature equilibrates to the temperature of the ambient atmosphere, the condensate evaporates and the surface returns to its original conditions. The fast cooling of the surface may be achieved by forcing gas from a small nozzle located in the vicinity of the surface subject to inspection. Thermionically, adiabatic expansion of gas leads to cooling by work on the surrounding atmosphere. Simply put, as a gas (e.g., air) expands, the volume increases, and this has the effect of increasing its internal energy. As the energy needed to increase the temperature must be supplied from somewhere, the gas takes the energy from the surrounding system giving the effect of cooling

In embodiments, the fluid stream includes a fluid stream including a fluid different from the ambient fluid surrounding the sample. For example, the fluid stream 118 may include a gas stream formed from a gas that is different from the gas contained within the chamber 114. For example, the fluid stream 118 may include a carbon monoxide gas stream or a hydrogen gas stream. In this embodiment, depending on the metal composition of the surface and the composition of the fluid, under specific thermodynamic conditions (e.g., temperature, pressure, etc.), or/and electrostatic potential, a film of the absorbate is formed on the surfaces. Condensed molecules of the gas act as light scattering centers enhancing the diffuse reflective properties of the surface. For example, adsorption on metal surfaces used in catalytic reaction may be applied in embodiments of the present disclosure. For example, a gold surface may result in catalytic carbon monoxide (CO) oxidations to carbon dioxide CO₂. By way of another example, a nickel surface may result in a catalytic reaction of hydrogen with various compounds.

In embodiments, the one or more reflective components of the sample may be treated with an additional fluid stream. In turn, the one or more reflective components of the sample may be imaged following the treatment of the one or more reflective components 116 of the sample 102 with the additional fluid stream. For example, the additional fluid stream may deliver the same fluid as the first fluid stream 118. By way of another example, the additional fluid stream may deliver a different fluid than the first fluid stream 118. In embodiments, the one or more fluid deliver nozzles 108 may comprise multiple fluid delivery nozzles. For example, the multiple fluid delivery nozzles may be operated independently and selectively for applying fluids from multiple directions, providing a combination of fluids, or designating some nozzles to supply fluids at elevated temperature for fast heating. For instance, as shown in FIG. 2D, a first fluid delivery nozzle 108a may deliver a first fluid stream 118a, while a second fluid delivery nozzle 108b may deliver a second fluid stream 118b.

Sample 102 may include any sample known in the art such as, but not limited to, a wafer, reticle, photomask, or the like. The dimensions of sample 102 under inspection are such that inspecting the entire sample 102 typically involves scanning it relative to the inspection head. The scanning may be accomplished by moving the stage and/or moving the inspection head relative to the sample 102. The stage 106 may include any stage known in the art including, but not limited to, an X-Y stage, an R-θ stage, and the like.

The illumination source 111 may include any illumination source known in the art. For example, the illumination source 111 may include one or more lasers. By way of another example, the illumination source 111 may include one or more broadband sources. The one or more optical elements components 110 of the inspection system 100 may include any illumination optics or collection optics known in the art. For example, in the case of illumination optics, the one or more optical components 110 may include, but are not limited to, beam splitters, mirrors, lenses, apertures, and waveplates that are configured to condition and direct light to sample 102. The optical components may be configured to illuminate an area, a line, or a spot on sample 102. In the case of collection optics, the one or more optical components 110 may include, but are not limited to, beam splitters, mirrors, lenses, apertures, and waveplates that are configured to collect, condition, and direct light to camera 112.

The camera 112 may include any sensor or detector known in the art. For example, the camera 112 may include, but is not limited to, a charge-coupled devices (CCD), complementary metal oxide semiconductor (CMOS) devices, time-delay integration (TDI) devices, or the like.

In embodiments, camera 112 is communicatively coupled to a controller 121. The controller may include one or more processors and memory. The controller 121 is configured to store and/or analyze data from the camera 112 under control of program instructions stored in the memory. The program instructions may be further configured to cause the one or more processors of the controller 121 to control other elements of inspection system 100 such as stage 106, the fluid nozzle 108 (or a valve coupled to the nozzle), the illumination source 111, camera 112, and/or one or more optical components 110.

The one or more processors of the present disclosure may include any one or more processing elements known in the art. In this sense, the one or more processors may include any microprocessor-type device configured to execute software algorithms and/or instructions. In embodiments, the one or more processors may consist of a desktop computer, mainframe computer system, workstation, image computer, parallel processor, or other computer system (e.g., networked computer) configured to execute a program configured to operate as described throughout the present disclosure. It should be recognized that the steps described throughout the present disclosure may be carried out by a single computer system or, alternatively, multiple computer systems. In general, the term “processor” may be broadly defined to encompass any device having one or more processing elements, which execute program instructions from a non-transitory memory medium. Moreover, different subsystems of the various systems disclosed may include processor or logic elements suitable for carrying out at least a portion of the steps described throughout the present disclosure. Therefore, the above description should not be interpreted as a limitation on the present disclosure but merely an illustration.

The memory medium may include any storage medium known in the art suitable for storing program instructions executable by the associated one or more processors. For example, the memory medium may include a non-transitory memory medium. For instance, the memory medium may include, but is not limited to, a read-only memory, a random-access memory, a magnetic or optical memory device (e.g., disk), a magnetic tape, a solid-state drive, and the like. In embodiments, the memory is configured to store one or more results and/or outputs of the various steps described herein. It is further noted that memory may be housed in a common controller housing with the one or more processors. In an alternative embodiment, the memory may be located remotely with respect to the physical location of the processors. For instance, the one or more processors may access a remote memory (e.g., server), accessible through a network (e.g., internet, intranet, and the like). In embodiments, the memory medium maintains program instructions for causing the one or more processors to carry out the various steps described through the present disclosure.

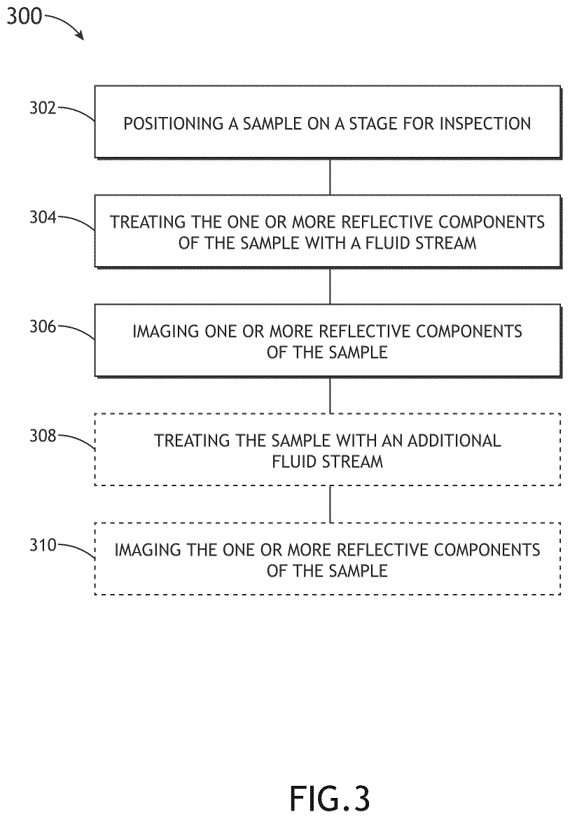

FIG. 3 is a flow diagram illustrating steps performed in a method 300 of reflection-enhanced inspection, in accordance with one embodiment of the present disclosure. It is noted herein that the steps of method 300 may be implemented all or in part by the system 100. It is further recognized, however, that the method 300 is not limited to the system 100 in that additional or alternative system-level embodiments may carry out all or part of the steps of method 300.

In step 302, a sample is positioned on a stage for inspection with an inspection tool. For example, as shown in FIG. 2, the sample 102 including one or more reflective components 116 is positioned on the stage 102 for inspection of the sample 102.

In step 304, one or more reflective components of the sample are treated with a fluid stream. For example, as shown in FIG. 2A-2C, the one or more reflective components 116 of the sample 102 are treated with a fluid stream 118 (e.g., gas or liquid) to temporarily adsorb a material to create an absorption layer 124 on a surface of the one or more reflective components 116 of the sample 102. The adsorbed material within the adsorption layer 124 causes temporary enhancement of diffuse scattering 120 from the one or more reflective components 116 of the sample 102 relative to specular reflection 122.

In step 306, one or more reflective components 116 of the sample 102 are imaged. For example, as shown in FIG. 2C, the one or more reflective components 116 are imaged by camera 112 during the temporary enhancement of diffuse scattering 120 from the one or more reflective components of the sample 102.

In step 308, the one or more reflective components 116 of the sample 102 may be treated with an additional fluid stream. For example, the additional fluid stream may deliver the same fluid (e.g., gas) as the first fluid stream. By way of another example, the additional fluid stream may deliver a different fluid (e.g., gas 2) than the first fluid stream (e.g., gas 1). For instance, as shown in FIG. 2D, a first fluid delivery nozzle 108a may deliver a first fluid stream 118a, while a second fluid delivery nozzle 108b may deliver a second fluid stream 118b. It is noted that the scope of the present disclosure is not limited to two fluid delivery nozzles/fluid stream as it is contemplated that the system 100 may include any number of fluid delivery nozzles (e.g., 1, 2, 3, 4, and so on) which deliver any number of fluid streams (e.g., 1, 2, 3, 4, and so on) of any type of fluid.

In step 310, one or more reflective components 116 of the sample 102 are imaged following the treatment of the one or more reflective components 116 of the sample 102 with the additional fluid stream. For example, as shown in FIG. 2C, the one or more reflective components 116 are imaged by camera 112 during the temporary enhancement of diffuse scattering 120 from the one or more reflective components of the sample 120

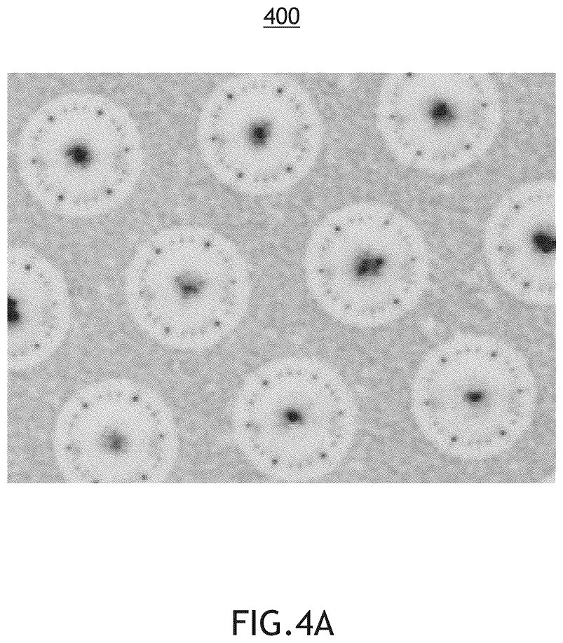

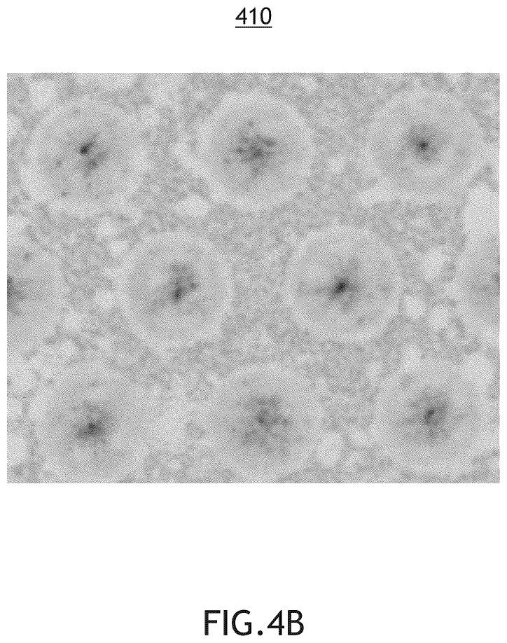

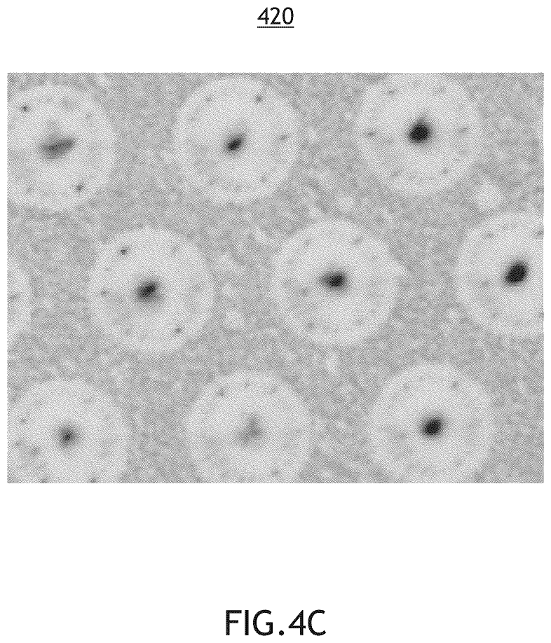

FIGS. 4A-4C depict a series of images obtained from a sample with reflective curved components illustrating the inspection enhancement of the present disclosure. As shown in FIG. 4A, a bright light microscope image 400 detecting specular reflection of a 3D metal structure (more specifically a ball structure with solder metal such as Sn) is shown. It can clearly be seen that the top of the surface is highly reflective, hence the contrast difference between the top and the rest of the ball structure as well as the substrate signal is very large. In contrast, FIG. 4B illustrates image 410 depicting the same structures after the application of a gas stream as described throughout the present disclosure. The metal ball surface appears as a diffusive surface in image 410. In turn, FIG. 4C illustrates image 420 depicting the reversibility of the process whereby the gas adsorption on the surfaces of the objects is observed to return to the original state as observed by the change from diffuse reflection back to surface specularity after a period of time.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The description is presented to enable one of ordinary skill in the art to make and use the disclosure as provided in the context of a particular application and its requirements. As used herein, directional terms such as “top,” “bottom,” “over,” “under,” “upper,” “upward,” “lower,” “down,” and “downward” are intended to provide relative positions for purposes of description and are not intended to designate an absolute frame of reference. Various modifications to the preferred embodiment will be apparent to those with skill in the art, and the general principles defined herein may be applied to other embodiments. Therefore, the present disclosure is not intended to be limited to the particular embodiments shown and described but is to be accorded the widest scope consistent with the principles and novel features herein disclosed.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A method of comprising:
positioning a sample including one or more reflective components on a stage;
treating the one or more reflective components of the sample with a fluid stream to temporarily adsorb a material on a surface of the one or more reflective components of the sample to cause temporary enhancement of diffuse scattering from the one or more reflective components of the sample; and
imaging the one or more reflective components of the sample during the temporary enhancement of diffuse scattering from the one or more reflective components of the sample.

2. The method of claim 1, wherein the temporary enhancement of diffuse scattering from the one or more reflective components of the sample comprises:
increasing an amount of diffuse scattering from the one or more reflective components relative to an amount of specular scattering from the one or more reflective components.

3. The method of claim 1, wherein the fluid stream is supplied by a fluid nozzle.

4. The method of claim 1, wherein the fluid stream comprises an ambient fluid stream.

5. The method of claim 4, wherein the ambient fluid stream cools the one or more reflective components to cause water adsorption on a surface of the one or more reflective components.

6. The method of claim 5, wherein the ambient fluid stream cools the one or more reflective components via adiabatic expansion of the ambient fluid surrounding the reflective components.

7. The method of claim 1, wherein the fluid stream contains at least one of a gas or liquid.

8. The method of claim 1, wherein the fluid stream comprises a fluid stream delivery fluid different from an ambient fluid surrounding the sample.

9. The method of claim 8, wherein the fluid stream comprises a carbon monoxide fluid stream or a hydrogen fluid stream.

10. The method of claim 1, further comprising:
treating the one or more reflective components of the sample with an additional fluid stream; and
imaging the one or more reflective components of the sample following the treating of the one or more reflective components of the sample with the additional fluid stream.

11. The method of claim 1, wherein the additional fluid stream delivers the same fluid as the fluid stream.

12. The method of claim 1, wherein the additional fluid stream delivers a different fluid than the fluid stream.

13. An inspection system comprising:
a stage, wherein the stage is configured to secure a sample including one or more reflective components;
an optical sub-system, wherein the optical sub-system includes an illumination source, one or more optical elements, and a camera;
one or more fluid delivery nozzles positioned proximate to the stage, wherein the one or more fluid delivery nozzles are configured to deliver a fluid to the one or more reflective components of the sample via a fluid stream to temporarily cause adsorption of a material on a surface of the one or more reflective components of the sample to cause temporary enhancement of diffuse scattering from the one or more reflective components of the sample,
wherein the camera is configured to image the one or more reflective components of the sample during the temporary enhancement of diffuse scattering from the one or more reflective components of the sample.

14. The system of claim 13, further comprising a controller including one or more processors and memory, wherein the memory stores program instructions.

15. The system of claim 14, wherein the program instructions are configured to control fluid flow through the one or more fluid delivery nozzles.

16. The system of claim 15, wherein the program instructions are configured to cause the one or more fluid nozzles to deliver at least one of the fluid streams or an additional fluid stream to the one or more reflective components.

17. The system of claim 13, wherein the additional fluid stream delivers the same fluid as the fluid stream.

18. The system of claim 13, wherein the additional fluid stream delivers a different fluid than the fluid stream.

19. The system of claim 13, wherein the fluid stream contains at least one of a gas or liquid.

20. The system of claim 13, wherein the program instructions are configured to control the camera to acquire images during the temporary enhancement of diffuse scattering from the one or more reflective components of the sample.

21. The system of claim 13, wherein the program instructions are configured to cause the one or more processors to control movement of at least one of the stage or an imaging head of the optical sub-system to cause relative scanning motion between the stage and the imaging head of the optical sub-system.

22. The system of claim 13, wherein the temporary enhancement of diffuse scattering from the one or more reflective components of the sample comprises:
increasing the amount of diffuse scattering from the one or more reflective components relative to the amount of specular scattering from the one or more reflective components.

23. The system of claim 13, wherein the fluid stream comprises an ambient fluid stream.

24. The system of claim 23, wherein the ambient fluid stream cools the one or more reflective components cools the one or more reflective components to cause water adsorption on a surface of the one or more reflective components.

25. The system of claim 24, wherein the ambient fluid stream cools the one or more reflective components via adiabatic expansion of the ambient fluid surrounding the reflective components.

26. The system of claim 13, wherein the fluid stream comprises a fluid stream different from an ambient fluid surrounding the sample.

27. The system of claim 26, wherein the fluid stream different from the ambient fluid comprises a carbon monoxide fluid stream or a hydrogen fluid stream.
